(19) United States
(12) Patent Application Publication
(10) Pub. No.: US 2026/0121132 A1
(43) Pub. Date: Apr. 30, 2026

(54) METHOD FOR SYNTHESIZING MIXED ZIRCONIUM SALT ELECTROLYTE MATERIAL AND USE IN LITHIUM METAL BATTERY

(71) Applicant: SOUTH CHINA UNIVERSITY OF TECHNOLOGY, Guangzhou (CN)

(72) Inventors: Keyou Yan, Guangzhou (CN); Yongcai Qiu, Guangzhou (CN); Qingshuai Xu, Guangzhou (CN); Guangxu Chen, Guangzhou (CN)

(21) Appl. No.: 19/433,114

(22) Filed: Dec. 26, 2025

Related U.S. Application Data
(63) Continuation of application No. PCT/CN2021/127802, filed on Oct. 31, 2021.

(30) Foreign Application Priority Data
Jun. 29, 2021 (CN) 202110730158.4

(51) Int. Cl. H01M 10/42; H01M 10/0525; H01M 10/0568; H01M 10/0569

(52) U.S. Cl. CPC H01M 10/4235; H01M 10/0525; H01M 10/0568; H01M 10/0569; H01M 2300/004

(57) ABSTRACT

The present invention provides a synthesis method for a mixed zirconium salt electrolyte material and use in a lithium metal battery. The preparation method includes the following steps: first, preparing a turbid solution of a zirconium-containing mixed electrolyte material using an existing commercial lithium battery electrolyte solution as a raw material; second, centrifuging the turbid solution obtained in the first step, taking a lower-layer precipitate, and then washing away excess impurities with a commercial carbonate electrolyte solution solvent; third, drying a white precipitate obtained after washing in the second step, and then grinding and pulverizing to obtain a mixed zirconium salt electrolyte material.

### CROSS REFERENCE TO THE RELATED APPLICATIONS

This application is a Continuation application of PCT Application No. PCT/CN2021/127802, filed on Oct. 31, 2021, which is based upon and claims priority to Chinese Patent Application No. 202110730158.4, filed on Jun. 29, 2021, the entire contents of which are incorporated herein by reference.

### TECHNICAL FIELD

The present invention belongs to the technical field of lithium-ion battery anodes, and particularly relates to a method for synthesizing a mixed zirconium salt electrolyte material and use in a lithium metal battery.

### BACKGROUND

The rapid development of electric vehicles and portable electronic products has spurred demand for higher energy density lithium-ion batteries. Lithium metal anodes are considered the ultimate anode material for lithium batteries due to their highest theoretical specific capacity (3860 mAh/g), lowest negative electrochemical potential (−3.4 V), and lighter weight. Lithium metal batteries can provide higher power and energy density, especially when combined with a high-voltage and high-specific-capacity high-nickel LiNiₓCo_{y}Mn_{1-x-y}O₂ (high-nickel NMC, Ni≥60%) cathode. However, highly active lithium metal anodes will undergo continuous side reactions with existing commercial carbonate electrolytes during charging and discharging, leading to a decrease in the coulombic efficiency (CE) and accelerated capacity decay of lithium batteries. In addition, the lithium dendrites produced by the side reactions can cause safety hazards such as battery short circuits, which seriously limits the practical application of rechargeable lithium metal batteries (LMB).

Electrolyte solutions are a very important component of lithium batteries. Existing commercial lithium battery electrolyte solutions mainly use lithium hexafluorophosphate (LiPF₆) as an electrolyte and carbonate organic solvents as a solvent. However, such electrolyte solutions cannot form a stable solid electrolyte interphase (SEI) film on the surface of the lithium metal anode of lithium metal batteries. Therefore, commercial carbonate electrolyte solutions will undergo continuous side reactions with the lithium metal anode, accelerating the capacity decay of lithium metal batteries. To prolong the cycle life of lithium metal batteries, existing lithium battery electrolyte solutions must be improved to enable the formation of a stable SEI film on the surface of the lithium metal anode, thereby suppressing the continuous side reactions between the electrolyte solutions and the lithium metal anode.

### SUMMARY

To overcome the defects of existing lithium battery electrolyte solution technologies, the present invention provides a method for synthesizing a mixed zirconium salt electrolyte material and use in a lithium metal battery. By adding the synthesized mixed zirconium salt electrolyte material to commercial lithium battery electrolyte solutions containing lithium hexafluorophosphate, the cycle stability of the lithium metal anode can be significantly improved, thereby significantly improving the rate performance of lithium metal batteries and prolonging the cycle life thereof.

The technical solutions used in the present invention are as follows:

A first objective of the present invention is to provide a synthesis method for a mixed zirconium salt electrolyte material, including the following steps:
(1) mixing lithium hexafluorophosphate (LiPF₆), an organic solvent in a lithium battery electrolyte solution, zirconium chloride (ZrCl₄), and lithium nitrate (LiNO₃), and stirring a mixed solution to obtain a yellow turbid solution;
(2) centrifuging the yellow turbid electrolyte solution obtained in step (1) using a centrifuge tube, then discarding an upper-layer supernatant, and taking a lower-layer precipitate; and
(3) washing the precipitate obtained in step (2) with a carbonate solvent in the lithium battery electrolyte solution, and then heating and drying a white precipitate after washing to finally obtain a mixed zirconium salt electrolyte material.

In the above method, in step (1), the organic solvent in the lithium battery electrolyte solution is one or more of ethylene carbonate (EC), diethyl carbonate (DEC), dimethyl carbonate (DMC), propylene carbonate (PC), and ethyl methyl carbonate (EMC).

In the above method, in step (3), washing the precipitate with the carbonate solvent specifically includes:
taking an equal mass of carbonate electrolyte solution solvent in step (1) to be injected into the centrifuge tube, stirring the carbonate electrolyte solution solvent and the precipitate obtained in step (2) to mix the carbonate electrolyte solution solvent and the precipitate thoroughly, then centrifuging to take a lower-layer precipitate, and then repeating such a procedure 1-3 times to obtain a pure mixed zirconium salt white precipitate.

In the above method, in step (3), specific conditions for the heating and drying are: drying at 40° C.-60° C. for 12-24 hours.

In the above method, in step (3), the carbonate solvent for washing is one of diethyl carbonate (DEC), dimethyl carbonate (DMC), propylene carbonate (PC), and ethyl methyl carbonate (EMC).

In the above method, in step (1), the lithium hexafluorophosphate (LiPF₆), the organic solvent in the lithium battery electrolyte solution, the zirconium chloride (ZrCl₄), and the lithium nitrate (LiNO₃) are mixed in the following mass ratio: 1-2:5-10:0.5-1:0.2-0.4.

In the above method, in step (1), conditions for the stirring are: stirring the mixed solution at 35° C. for 12 hours.

Using the preparation method provided by the present invention, the mixed zirconium salt electrolyte material with a very high degree of crystallinity can be prepared.

The final product prepared by the present invention is subjected to X-ray powder diffraction (XRD) and X-ray photoelectron spectroscopy (XPS) tests; FIG. 1 obtained by the XRD test verifies that the final product is a mixed zirconium salt crystal, and the mixed zirconium salt has a very high degree of crystallinity. XPS analysis results also verify the XRD results; as can be seen from FIG. 2 obtained by the XPS test, the material is a mixed zirconium salt composed of elements phosphorus (P), lithium (Li), fluorine (F), and zirconium (Zr); after analysis, the atomic ratio of the elements phosphorus (P), lithium (Li), fluorine (F), and zirconium (Zr) in the zirconium salt is approximately 4%:30%:24%:24%, and the zirconium salt is a mixed salt containing the element zirconium.

A second objective of the present invention is to provide a method for synthesizing a mixed zirconium salt electrolyte material and use in a lithium metal battery. The mixed zirconium salt electrolyte material is added to a lithium battery electrolyte solution containing lithium hexafluorophosphate (LiPF₆).

Preferably, in the lithium battery electrolyte solution, a mass ratio of the lithium battery electrolyte solution to the mixed zirconium salt electrolyte material is 10:0.5 to 10:1.5.

Preferably, a solvent in the lithium battery electrolyte solution is one or more of ethylene carbonate (EC), diethyl carbonate (DEC), dimethyl carbonate (DMC), propylene carbonate (PC), and ethyl methyl carbonate (EMC).

Compared with the prior art, the present invention has the following advantages and beneficial effects:
(1) Fewer synthesis steps and simple technology. The mixed zirconium salt electrolyte material can be obtained through simple mixing and stirring;
(2) By adding the mixed zirconium salt electrolyte material to existing lithium battery electrolyte solutions, the cycle life and rate performance of lithium metal batteries can be significantly improved. The conclusion is demonstrated in Comparative Example 1 and Example 9 in the embodiments.

### BRIEF DESCRIPTION OF DRAWINGS

FIG. 1 shows an XRD diffraction pattern of a mixed zirconium salt electrolyte material;

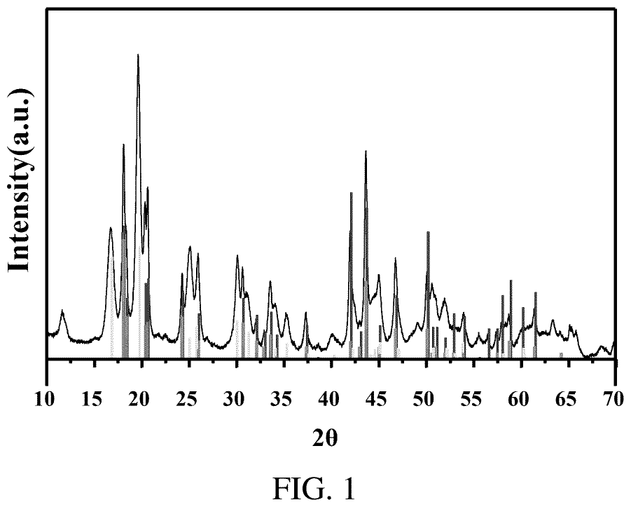

FIG. 2 shows XPS analysis charts of a mixed zirconium salt electrolyte material;

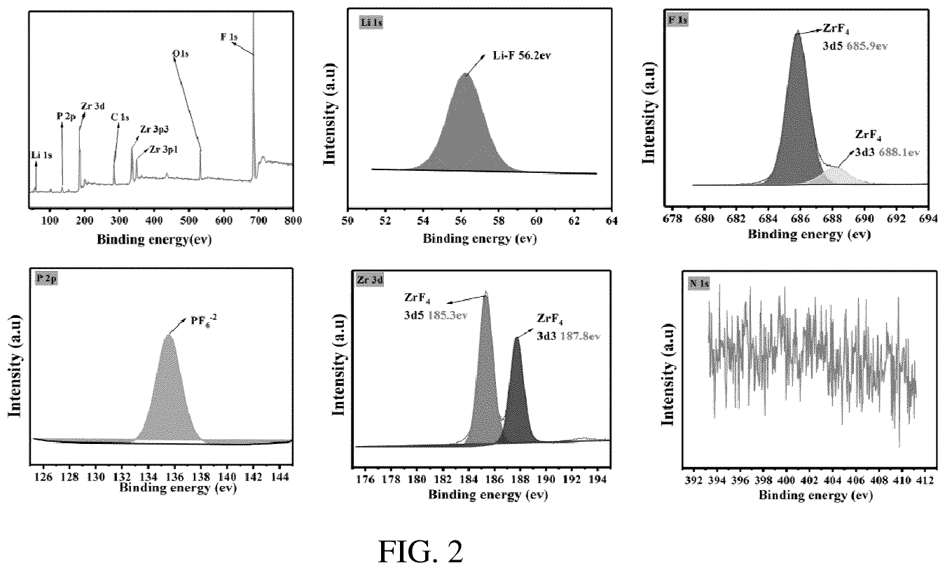

FIG. 3 shows performance comparison charts between a mixed zirconium salt electrolyte solution obtained in Example 6 and a commercially available ordinary lithium battery electrolyte solution in a comparative example within 1300 charge-discharge cycles in a lithium metal battery.

### DETAILED DESCRIPTION OF EMBODIMENTS

The present invention will be further described in detail below in conjunction with specific embodiments, but the implementation of the present invention is not limited thereto. For process parameters not specifically noted, conventional techniques can be referred to.

A synthesis method for a mixed zirconium salt electrolyte material of the present invention, including the following steps:
(1) mixing lithium hexafluorophosphate (LiPF₆), an organic solvent in a lithium battery electrolyte solution, zirconium chloride (ZrCl₄), and lithium nitrate (LiNO₃), and stirring a mixed solution to obtain a yellow turbid solution;
(2) centrifuging the yellow turbid electrolyte solution obtained in step (1) using a centrifuge tube, then discarding an upper-layer supernatant, and taking a lower-layer precipitate; and
(3) washing the precipitate obtained in step (2) with a carbonate solvent in the lithium battery electrolyte solution, and then heating and drying a white precipitate after washing to finally obtain a mixed zirconium salt electrolyte;

In the above method, in step (1), the organic solvent in the lithium battery electrolyte solution is one or more of ethylene carbonate (EC), diethyl carbonate (DEC), dimethyl carbonate (DMC), propylene carbonate (PC), and ethyl methyl carbonate (EMC).

In the above method, in step (3), washing the precipitate with the carbonate solvent specifically includes:
taking an equal mass of carbonate electrolyte solution solvent in step (1) to be injected into the centrifuge tube, stirring the carbonate electrolyte solution solvent and the precipitate obtained in step (2) to mix the carbonate electrolyte solution solvent and the precipitate thoroughly, then centrifuging to take a lower-layer precipitate, and then repeating such a procedure 1-3 times to obtain a pure mixed zirconium salt white precipitate.

In the above method, in step (3), specific conditions for the heating and drying are: drying at 40° C.-60° C. for 12-24 hours.

In the above method, in step (3), the carbonate solvent for washing is one of diethyl carbonate (DEC), dimethyl carbonate (DMC), propylene carbonate (PC), and ethyl methyl carbonate (EMC).

In the above method, in step (1), the lithium hexafluorophosphate (LiPF₆), the organic solvent in the lithium battery electrolyte solution, the zirconium chloride (ZrCl₄), and the lithium nitrate (LiNO₃) are mixed in the following mass ratio: 1-2:5-10:0.5-1:0.2-0.4.

In the above method, in step (1), conditions for the stirring are: stirring the mixed solution at 35° C. for 12 hours.

### Example 1

(1) Lithium hexafluorophosphate (LiPF₆), a mixed carbonate solvent (with a mass ratio of EMC:DEC:EC being 5:2:3), zirconium chloride (ZrCl₄), and lithium nitrate (LiNO₃) were mixed in a mass ratio of 1.5:10:0.5:0.3, and the mixed solution was then stirred at 35° C. for 12 hours to obtain a yellow turbid solution;
(2) Then, the yellow turbid electrolyte solution obtained was centrifuged using a centrifuge tube, and an upper-layer supernatant was discarded to leave a precipitate;
(3) An equal mass of EMC solvent in step (1) was taken to be injected into the centrifuge tube for shaking and washing. Centrifugation was then carried out, and an upper-layer supernatant in the centrifuge tube was discarded to leave a precipitate. This step was repeated again to ensure that the impurity ions had been removed by the EMC solvent.
(4) The white precipitate obtained in step (3) was subjected to vacuum drying at 50° C. for 24 hours. After natural cooling, the white precipitate was ground and pulverized to obtain a mixed zirconium salt electrolyte material.

### Example 2

(1) Lithium hexafluorophosphate (LiPF₆), propylene carbonate (PC), zirconium chloride (ZrCl₄), and lithium nitrate (LiNO₃) were mixed in a mass ratio of 1.5:10:0.5:0.3, and the mixed solution was then stirred at 35° C. for 12 hours to obtain a yellow turbid solution;
(2) Then, the yellow turbid electrolyte solution obtained was centrifuged using a centrifuge tube, and an upper-layer supernatant was discarded to leave a precipitate;
(3) An equal mass of propylene carbonate (PC) solvent in step (1) was taken to be injected into the centrifuge tube for shaking and washing. Centrifugation was then carried out, and an upper-layer supernatant in the centrifuge tube was discarded to leave a precipitate. This step was repeated again to ensure that the impurity ions had been removed by the propylene carbonate (PC) solvent.
(4) The white precipitate obtained in step (3) was subjected to vacuum drying at 50° C. for 24 hours. After natural cooling, the white precipitate was ground and pulverized to obtain a mixed zirconium salt electrolyte material.

### Example 3

(1) Lithium hexafluorophosphate (LiPF₆), a mixed carbonate solvent (with a mass ratio of EMC:DEC:EC being 5:2:3), zirconium chloride (ZrCl₄), and lithium nitrate (LiNO₃) were mixed in a mass ratio of 1:10:0.5:0.2, and the mixed solution was then stirred at 35° C. for 12 hours to obtain a yellow turbid solution;
(2) Then, the yellow turbid electrolyte solution obtained was centrifuged using a centrifuge tube, and an upper-layer supernatant was discarded to leave a precipitate;
(3) An equal mass of EMC solvent in step (1) was taken to be injected into the centrifuge tube for shaking and washing. Centrifugation was then carried out, and an upper-layer supernatant in the centrifuge tube was discarded to leave a precipitate. This step was repeated again to ensure that the impurity ions had been removed by the EMC solvent.
(4) The white precipitate obtained in step (3) was subjected to vacuum drying at 40° C. for 24 hours. After natural cooling, the white precipitate was ground and pulverized to obtain a mixed zirconium salt electrolyte material.

### Example 4

(1) Lithium hexafluorophosphate (LiPF₆), a mixed carbonate solvent (with a mass ratio of EMC:DEC:EC being 5:2:3), zirconium chloride (ZrCl₄), and lithium nitrate (LiNO₃) were mixed in a mass ratio of 2:10:1:0.4, and the mixed solution was then stirred at 35° C. for 12 hours to obtain a yellow turbid solution;
(2) Then, the yellow turbid electrolyte solution obtained was centrifuged using a centrifuge tube, and an upper-layer supernatant was discarded to leave a precipitate;
(3) An equal mass of EMC solvent in step (1) was taken to be injected into the centrifuge tube for shaking and washing. Centrifugation was then carried out, and an upper-layer supernatant in the centrifuge tube was discarded to leave a precipitate. This step was repeated again to ensure that the impurity ions had been removed by the EMC solvent.
(4) The white precipitate obtained in step (3) was subjected to vacuum drying at 60° C. for 24 hours. After natural cooling, the white precipitate was ground and pulverized to obtain a mixed zirconium salt electrolyte material.

### Example 5

The mixed zirconium salt electrolyte material prepared in Example 1 was added to a lithium battery electrolyte solution containing lithium hexafluorophosphate in a mass ratio of 0.5:10. The solvent in the lithium battery electrolyte solution was a mixed carbonate solvent (with a mass ratio of EMC:DEC:EC being 5:2:3), and the molar concentration of lithium hexafluorophosphate in the lithium battery electrolyte solution was 1 mol/L.

### Example 6

The mixed zirconium salt electrolyte material prepared in Example 2 was added to a lithium battery electrolyte solution containing lithium hexafluorophosphate in a mass ratio of 0.5:10. The solvent in the lithium battery electrolyte solution was PC, and the molar concentration of lithium hexafluorophosphate in the lithium battery electrolyte solution was 1 mol/L.

### Example 7

The mixed zirconium salt electrolyte material prepared in Example 1 was added to a lithium battery electrolyte solution containing lithium hexafluorophosphate in a mass ratio of 1.5:10. The solvent in the lithium battery electrolyte solution was a mixed carbonate solvent (with a mass ratio of EMC:DEC:EC being 5:2:3), and the molar concentration of lithium hexafluorophosphate in the lithium battery electrolyte solution was 1 mol/L.

### Example 8

The mixed zirconium salt electrolyte material prepared in Example 1 was added to a lithium battery electrolyte solution containing lithium hexafluorophosphate in a mass ratio of 1:10. The solvent in the lithium battery electrolyte solution was a mixed carbonate solvent (with a mass ratio of DEC:EC being 2:3), and the molar concentration of lithium hexafluorophosphate in the lithium battery electrolyte solution was 1 mol/L.

### Comparative Example 1

In the comparative example, the electrolyte solution used was a commercially available ordinary lithium battery electrolyte solution. The solvent in the lithium battery electrolyte solution was a mixed carbonate solvent (with a mass ratio of EMC:DEC:EC being 5:2:3), and the molar concentration of lithium hexafluorophosphate in the lithium battery electrolyte solution was 1 mol/L. The lithium battery electrolyte solution was purchased from Guangzhou Tinci Materials Technology Co., Ltd.

### Example 9

The mixed zirconium salt-containing electrolyte solution prepared in Example 1 was compared with the lithium battery electrolyte solution in the comparative example: the electrolyte solution in Example 1 and the electrolyte solution in the comparative example were added to lithium metal button batteries in an E/C (Electrolyte/Capacity) ratio of 3:1, the anode of the lithium metal button batteries was a carbon cloth/lithium metal composite anode, and the cathode was a lithium iron phosphate material with an active material loading of 14 mg/cm⁻². The lithium metal button batteries were first cycled 8 times at rates for rate charge and discharge of 0.3 C, 1 C, 2 C, 5 C, and 3 C (1 C=170 mAh/g), and then cycled 1300 times at a rate of 1 C.

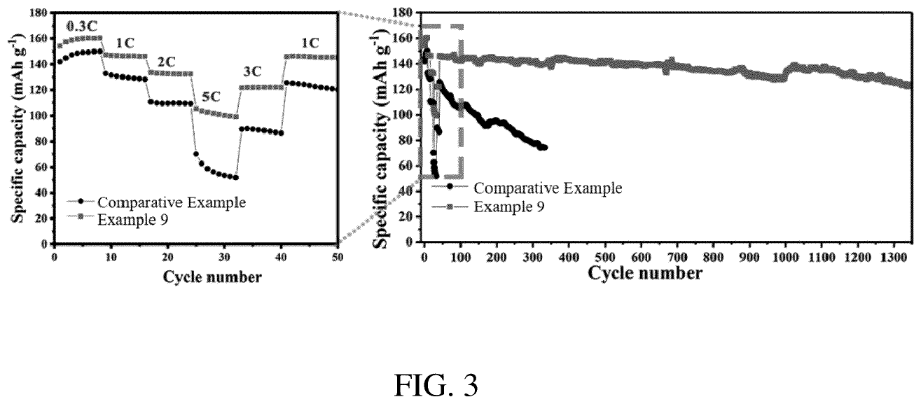

The performance comparison of the lithium metal button batteries is shown in FIG. 3. After undergoing rate charge-discharge cycles, the lithium metal battery injected with the electrolyte solution prepared in Example 1 still had a specific capacity of 123 mAh/g after 1300 stable cycles, and a capacity retention rate of 85%. During the rate charge, it still had a specific capacity of approximately 95 mAh/g when charging and discharging at a high rate of 5 C. The lithium metal button battery using the lithium battery electrolyte solution in the comparative example was far inferior to the lithium metal battery injected with the electrolyte solution prepared in Example 1, both in the rate charge-discharge process and in the subsequent long-term cycling process.

Practice has shown that the mixed zirconium salt electrolyte material prepared by the method is a high-performance lithium battery electrolyte solution additive. The mixed zirconium salt electrolyte material can significantly improve the rate performance of lithium metal batteries and prolong the cycle life thereof, making it a very ideal electrolyte solution additive for the preparation of high-energy and high-power lithium metal batteries.

Example 1 mentioned above is a preferred embodiment of the present invention. However, the embodiments of the present invention are not limited to Example 1 mentioned above. Any other changes, modifications, substitutions, combinations, or simplifications made without departing from the spirit and principle of the present invention shall be considered equivalent substitutions and shall be included within the protection scope of the present invention.

1. A synthesis method for a mixed zirconium salt electrolyte material, comprising the following steps:
(1) mixing lithium hexafluorophosphate (LiPF₆), an organic solvent in a lithium battery electrolyte solution, zirconium chloride (ZrCl₄), and lithium nitrate (LiNO₃), and stirring a mixed solution to obtain a yellow turbid solution;
(2) centrifuging the yellow turbid solution obtained in step (1) using a centrifuge tube, then discarding an upper-layer supernatant, and taking a lower-layer precipitate; and
(3) washing the precipitate obtained in step (2) with a carbonate solvent in the lithium battery electrolyte solution, and then heating and drying a white precipitate after washing to finally obtain a mixed zirconium salt electrolyte material.

2. The synthesis method for a mixed zirconium salt electrolyte material according to claim 1, wherein in step (1), the organic solvent in the lithium battery electrolyte solution is one or more of ethylene carbonate (EC), diethyl carbonate (DEC), dimethyl carbonate (DMC), propylene carbonate (PC), and ethyl methyl carbonate (EMC).

3. The synthesis method for a mixed zirconium salt electrolyte material according to claim 1, wherein in step (3), washing the precipitate with the carbonate solvent specifically comprises:
taking an equal mass of carbonate electrolyte solution solvent in step (1) to be injected into the centrifuge tube, stirring the carbonate electrolyte solution solvent and the precipitate obtained in step (2) to mix the carbonate electrolyte solution solvent and the precipitate thoroughly, then centrifuging to take a lower-layer precipitate, and then repeating such a procedure 1-3 times to obtain a pure mixed zirconium salt white precipitate.

4. The synthesis method for a mixed zirconium salt electrolyte material according to claim 1, wherein in step (3), specific conditions for the heating and drying are: drying at 40° C.-60° C. for 12-24 hours.

5. The synthesis method for a mixed zirconium salt electrolyte material according to claim 1, wherein in step (3), the carbonate solvent for washing is one of diethyl carbonate (DEC), dimethyl carbonate (DMC), propylene carbonate (PC), and ethyl methyl carbonate (EMC).

6. The synthesis method for a mixed zirconium salt electrolyte material according to claim 1, wherein in step (1), the lithium hexafluorophosphate (LiPF₆), the organic solvent in the lithium battery electrolyte solution, the zirconium chloride (ZrCl₄), and the lithium nitrate (LiNO₃) are mixed in the following mass ratio: 1-2:5-10:0.5-1:0.2-0.4.

7. The synthesis method for a mixed zirconium salt electrolyte material according to claim 1, wherein in step (1), conditions for the stirring are: stirring the mixed solution at 35° C. for 12 hours.

8. Use of the mixed zirconium salt electrolyte material prepared by the synthesis method according to claim 1 in a lithium metal battery, wherein the mixed zirconium salt electrolyte material is added to a lithium battery electrolyte solution containing lithium hexafluorophosphate (LiPF₆).

9. The use of the mixed zirconium salt electrolyte material in a lithium metal battery according to claim 8, wherein in the lithium battery electrolyte solution, a mass ratio of the lithium battery electrolyte solution to the mixed zirconium salt electrolyte material is 10:0.5 to 10:1.5.

10. The use of the mixed zirconium salt electrolyte material in a lithium metal battery according to claim 8, wherein a solvent in the lithium battery electrolyte solution is one or more of ethylene carbonate (EC), diethyl carbonate (DEC), dimethyl carbonate (DMC), propylene carbonate (PC), and ethyl methyl carbonate (EMC).
